(19) United States
(12) Patent Application Publication
(10) Pub. No.: US 2017/0239017 A1
(43) Pub. Date: Aug. 24, 2017

(54) ORTHODONTIC TREATMENT METHOD USING AESTHETIC GUIDE LINE

(71) Applicant: eClear International Co., Ltd., Los Angeles, CA (US)

(72) Inventor: TAEWEON KIM, Seoul (KR)

(21) Appl. No.: 15/051,862

(22) Filed: Feb. 24, 2016

(51) Int. Cl. A61C 7/00; A61C 7/08

(52) U.S. Cl. CPC A61C 7/002; A61C 7/08

(57) ABSTRACT

Provided is an orthodontic treatment method using an aesthetic guideline. The method includes expanding anterior teeth or other teeth such that front lines of the anterior teeth move to a front side of the aesthetic guide line corresponding to a virtual line obtained by connecting a first skin point to a second skin point located in front of a pogonion; aligning the anterior teeth or the other teeth from a first angle to a second angle such that central tangent lines of the front lines of the anterior teeth are parallel to the aesthetic guide line; and retracting the anterior teeth or the other teeth such that the central tangent lines of the front lines of the anterior teeth overlap with the aesthetic guide line or are located at an inner side of the aesthetic guide line.

### BACKGROUND

1. Field

The present invention relates to an orthodontic treatment method using an aesthetic guide line and, more particularly, to an orthodontic treatment method capable of ideally straightening teeth using an aesthetic guide line to achieve the most aesthetically beautiful face of an orthodontic patient.

2. Description of the Related Art

Orthodontic treatment may be classified into metal-brace treatment using metal braces, lingual treatment using lingual braces, and clear-aligner treatment using clear aligners.

In particular, clear-aligner treatment attracts people's attention compared to the other orthodontic treatment methods because a clear aligner covering teeth like a mouth piece is invisible, detachable, and easily wearable.

The above-described clear aligner is generally manufactured using a manual method of, for example, making a dental impression of an orthodontic patient to obtain a stone model of the teeth of the orthodontic patient, and then slightly moving every tooth of the teeth model by a skilled technician to vacuum-absorb a transparent base material onto the teeth model.

However, according to the above manual clear-aligner manufacturing method, since only the shape of teeth is focused and the correlation between the teeth and a whole face is not considered, although the teeth are uniformly straightened, the teeth are not aesthetically beautiful within the whole face.

Furthermore, in conventional cases, since a final orthodontic model of an orthodontic patient is not an ideal model but a non-standardized model dependent on a personal sense of beauty of a dentist or an orthodontist and is produced based on different standards, even similar types of orthodontic patients may experience a large difference in shape of straightened teeth, aesthetic satisfaction after orthodontic treatment may be low, and thus retreatment may be needed in worse cases.

### SUMMARY

The present invention provides an orthodontic treatment method capable of ideally straightening teeth using an aesthetic guide line to achieve the most aesthetically beautiful face of an orthodontic patient, remarkably improving satisfaction of the orthodontic patient and acquaintances thereof, reducing a retreatment rate, and deriving equal results of simulation irrespective of experience or ability of operators and thus greatly improving product uniformity or quality of a clear aligner by establishing the aesthetic guide line corresponding to an ideal orthodontic model and then simulating expansion, alignment, and retraction of the teeth on a computer using a virtual orthodontic arc based on the aesthetic guide line to manufacture the clear aligner. However, the scope of the present invention is not limited thereto.

According to an aspect of the present invention, there is provided an orthodontic treatment method using an aesthetic guide line, the method including an expansion stage for expanding anterior teeth or other teeth in such a manner that front lines of the anterior teeth move to a front side of the aesthetic guide line corresponding to a virtual line obtained by connecting a first skin point located in front of a nasion from which nasal bones start based on a profile skull line of an orthodontic patient, to a second skin point located in front of a pogonion, an alignment stage for aligning the anterior teeth or the other teeth from a first angle to a second angle in such a manner that central tangent lines of the front lines of the anterior teeth are parallel to the aesthetic guide line, and a retraction stage for retracting the anterior teeth or the other teeth in such a manner that the central tangent lines of the front lines of the anterior teeth overlap with the aesthetic guide line or are located at an inner side of the aesthetic guide line.

In the expansion stage, the teeth including the anterior teeth may be expanded and spaced apart from each other by a distance in such a manner that bottom width lines of the teeth are located on a virtual expanded orthodontic arc.

The distance may be 0.01 mm to 0.5 mm in such a manner that the teeth are rotatable.

In the retraction stage, the teeth including the anterior teeth are retracted to closely contact each other with no distance therebetween in such a manner that bottom width lines of the teeth are located on a virtual orthodontic arc or located at an inner side of the orthodontic arc.

The orthodontic arc may include a first arc on which bottom width lines of the teeth including at least the anterior teeth are located, and a second arc on which bottom width lines of the teeth including at least posterior teeth are located and which is located at an inner side of the first arc to be spaced apart from the first arc.

The orthodontic treatment method may further include an interproximal reduction (IPR)/stripping stage for placing the teeth on a preliminary orthodontic arc provided in front of a virtual orthodontic arc to closely contact each other with no distance therebetween and stripping side surfaces of one or more of the teeth, after the alignment stage, and, in the retraction stage, the anterior teeth or the other teeth located on the preliminary orthodontic arc may be retracted to the orthodontic arc in such a manner that the front lines of the anterior teeth overlap with the aesthetic guide line or are located at an inner side of the aesthetic guide line.

A clear aligner set for expanding, aligning, and retracting the anterior teeth may be used.

The clear aligner set may include three clear aligners having the same orthodontic space but formed of soft, medium, and hard materials or having first, second, and third thicknesses to apply gradually increasing orthodontic forces to the teeth in consideration of a recovery period of a human body.

### BRIEF DESCRIPTION OF THE DRAWINGS

The above and other features and advantages of the present invention will become more apparent by describing in detail embodiments thereof with reference to the attached drawings in which:

FIG. 1 is a side view of a face showing an aesthetic guide line used in an orthodontic treatment method according to some embodiments of the present invention;

FIG. 2 is a side view of anterior teeth showing an expansion stage of the orthodontic treatment method using the aesthetic guide line of FIG. 1;

FIG. 3 is a bottom view of an upper jaw showing the expansion stage of the orthodontic treatment method using the aesthetic guide line of FIG. 2;

FIG. 4 is a side view of the anterior teeth showing an alignment stage of the orthodontic treatment method using the aesthetic guide line of FIG. 1;

FIG. 5 is a bottom view of the upper jaw showing the alignment stage of the orthodontic treatment method using the aesthetic guide line of FIG. 4;

FIG. 6 is a side view of the anterior teeth showing a retraction stage of the orthodontic treatment method using the aesthetic guide line of FIG. 1;

FIG. 7 is a bottom view of the upper jaw showing the retraction stage of the orthodontic treatment method using the aesthetic guide line of FIG. 6;

FIGS. 8 to 11 are bottom views of an upper jaw sequentially showing operations for interproximal reduction (IPR)/stripping in an orthodontic treatment method using an aesthetic guide line, according to other embodiments of the present invention;

FIG. 12 is a bottom view of an upper jaw showing an orthodontic arc based on an orthodontic treatment method using an aesthetic guide line, according to still other embodiments of the present invention;

FIG. 13 is a cross-sectional view of a clear aligner set manufactured using an orthodontic treatment method using an aesthetic guide line, according to some embodiments of the present invention;

FIG. 14 is a perspective view of the clear aligner set of FIG. 13;

FIG. 15 is a flowchart of an orthodontic treatment method using an aesthetic guide line, according to some embodiments of the present invention;

FIG. 16 is a flowchart of an orthodontic treatment method using an aesthetic guide line, according to other embodiments of the present invention;

FIG. 17 is a side view of a face before orthodontic treatment showing an aesthetic guide line used in an orthodontic treatment method, according to still other embodiments of the present invention;

FIG. 18 is a side view of the face after orthodontic treatment showing the aesthetic guide line used in the orthodontic treatment method, according to still other embodiments of the present invention; and

FIG. 19 is a bottom image of the upper jaw showing the orthodontic arc based on the orthodontic treatment method using the aesthetic guide line, according to still other embodiments of the present invention.

### DETAILED DESCRIPTION

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses of layers are exaggerated for clarity.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of embodiments.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, the embodiments of the invention should not be construed as limited to the particular shapes of regions illustrated herein, but are to include deviations in shapes that result, for example, from manufacturing.

An orthodontic treatment method of the present invention may be used not only to actually straighten teeth of an orthodontic patient but also to simulate straightening of teeth in a virtual space of a computer.

That is, the orthodontic treatment method of the present invention be used not only for actual orthodontic treatment but also for orthodontic treatment simulation.

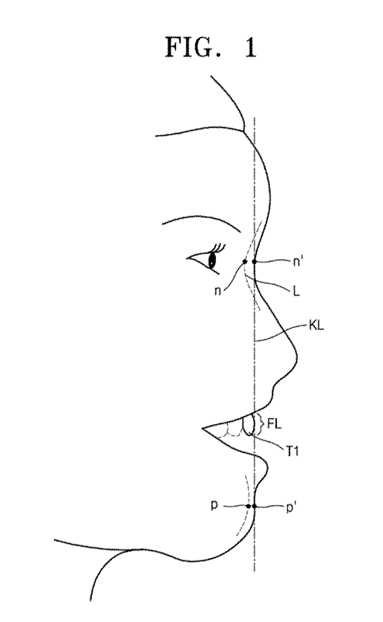

FIG. 1 is a side view of a face showing an aesthetic guide line KL used in an orthodontic treatment method according to some embodiments of the present invention.

Initially, as illustrated in FIG. 1, the aesthetic guide line KL according to the present invention may be a virtual line obtained by connecting a first skin point n′ located in front of a nasion n from which nasal bones start based on a profile skull line L of an orthodontic patient, to a second skin point p′ located in front of a pogonion p. The aesthetic guide line KL may be equally applied to the Mongoloid, Caucasoid, and Negroid irrespective of races.

The aesthetic guide line KL proposed by the present invention is a beauty guide line which considers the positions of teeth together with the shape of a face and serves as a basic line of the most aesthetically stable, beautiful, and ideal model proposed by the present invention.

The aesthetic guide line KL is derived by observing beautiful women and handsome men of all races and analyzing common features thereof in a statistical manner, and is very close to a public sense of beauty.

If there is no such guide line, dentists or orthodontists have different standards as in the conventional cases and thus a large number of errors will occur.

To prevent the errors, according to the present invention, an orthodontic treatment method to be described below may be performed using the proposed aesthetic guide line KL to straighten teeth.

For example, an orthodontic treatment method using an aesthetic guide line, according to some embodiments of the present invention, may largely include an expansion stage, an alignment stage, and a retraction stage.

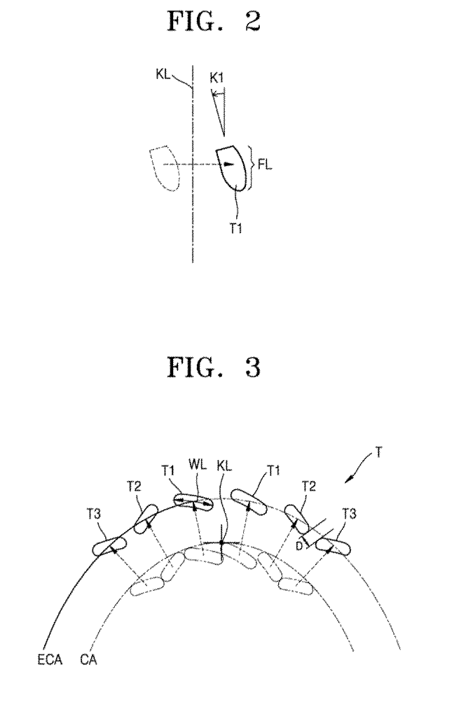

FIG. 2 is a side view of anterior teeth T1 showing an expansion stage of the orthodontic treatment method using the aesthetic guide line KL of FIG. 1, and FIG. 3 is a bottom view of an upper jaw showing the expansion stage of the orthodontic treatment method using the aesthetic guide line KL of FIG. 2.

Herein, the technical idea of the invention is applied to the upper jaw of FIG. 3, but is not applied thereto and may be equally applied to a lower jaw after the positions of teeth of the upper jaw are determined.

Initially, as illustrated in FIGS. 2 and 3, the expansion stage is a stage for expanding the anterior teeth T1 or other teeth T in such a manner that front lines FL of the anterior teeth T1 move to a front side of the aesthetic guide line KL. For example, the teeth T including the anterior teeth T1 may be expanded and spaced apart from each other by the shortest distance D in such a manner that bottom width lines WL of the teeth T are located on a virtual expanded orthodontic arc ECA.

Herein, the distance D may be 0.01 mm to 0.5 mm in consideration of orthodontic capability of an orthodontic patient and sizes, lengths, and angles of the teeth T in such a manner that the teeth T are rotatable. That is, if the distance D is smaller than the above-described range, the teeth T may not easily rotate. Otherwise, if the distance D is greater than the above-described range, the orthodontic patient may be excessively damaged, gingiva may be inflamed, and thus orthodontic treatment may be disabled.

In addition, the expanded orthodontic arc ECA may have a shape obtained by expanding an orthodontic arc CA to be described below, by a certain distance in front, left, and right directions. Herein, the expansion distance may be determined in consideration of resilience of an orthodontic patient, a treatment period, teeth conditions, etc.

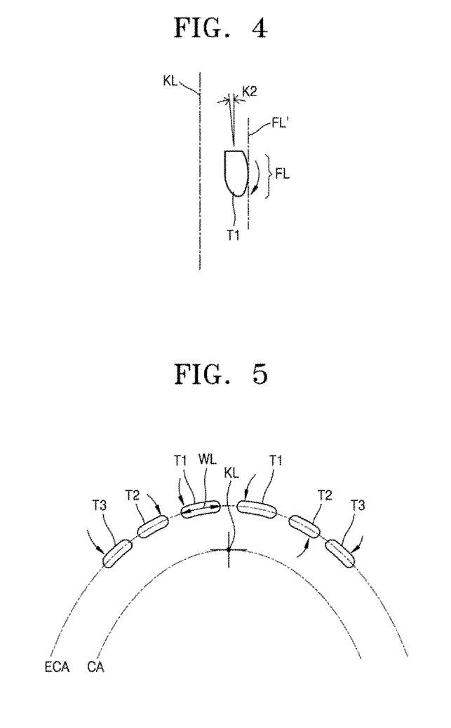

FIG. 4 is a side view of the anterior teeth T1 showing an alignment stage of the orthodontic treatment method using the aesthetic guide line KL of FIG. 1, and FIG. 5 is a bottom view of the upper jaw showing the alignment stage of the orthodontic treatment method using the aesthetic guide line KL of FIG. 4.

Subsequently, as illustrated in FIGS. 4 and 5, the alignment stage is a stage for aligning the anterior teeth T1 or the other teeth T from a first angle K1 to a second angle K2 in such a manner that central tangent lines FL′ of the front lines FL of the anterior teeth T1 are parallel to the aesthetic guide line KL. The first and second angles K1 and K2 are not limited to vertical angles of the teeth T and may also be applied to horizontal angles thereof.

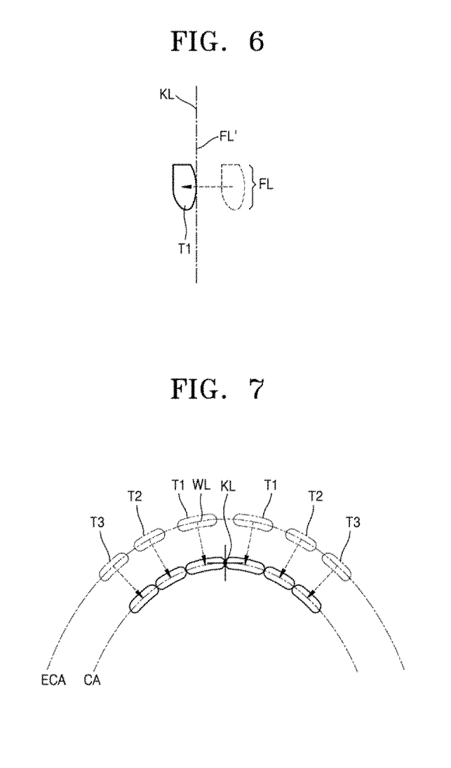

FIG. 6 is a side view of the anterior teeth T1 showing a retraction stage of the orthodontic treatment method using the aesthetic guide line KL of FIG. 1, and FIG. 7 is a bottom view of the upper jaw showing the retraction stage of the orthodontic treatment method using the aesthetic guide line KL of FIG. 6.

Subsequently, as illustrated in FIGS. 6 and 7, the retraction stage is a stage for retracting the anterior teeth T1 or the other teeth T in such a manner that the central tangent lines FL′ of the front lines FL of the anterior teeth T1 overlap with the aesthetic guide line KL or are located at an inner side of the aesthetic guide line KL. For example, the teeth T including the anterior teeth T1 may be retracted to closely contact each other with no distance therebetween in such a manner that the bottom width lines WL of the teeth T are located on the virtual orthodontic arc CA or located at an inner side of the orthodontic arc CA.

Herein, for example, if the orthodontic patient is a Mongoloid, the anterior teeth T1 or the other teeth T may be retracted in such a manner that the central tangent lines FL′ of the front lines FL of the anterior teeth T1 overlap with the aesthetic guide line KL. If the orthodontic patient is a Caucasoid having a sharp nose compared to the Mongoloid, the anterior teeth T1 or the other teeth T may be retracted in such a manner that the central tangent lines FL′ of the front lines FL of the anterior teeth T1 are located at an inner side of the aesthetic guide line KL. However, an ideal position thereof is not limited thereto and may be adjusted within a region defined by the aesthetic guide line KL.

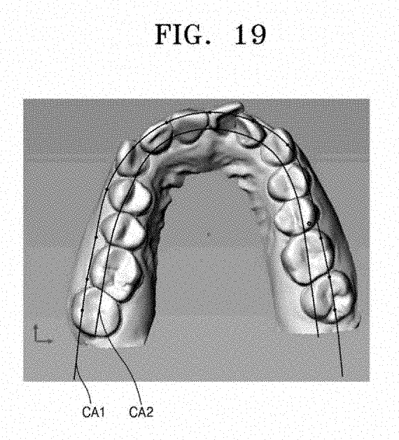

FIG. 12 is a bottom view of an upper jaw showing an orthodontic arc CA based on an orthodontic treatment method using an aesthetic guide line, according to still other embodiments of the present invention, and FIG. 19 is a bottom image of the upper jaw showing the orthodontic arc CA based on the orthodontic treatment method using the aesthetic guide line, according to still other embodiments of the present invention.

As illustrated in FIGS. 12 and 19, the orthodontic arc CA in a retraction stage may include a first arc CA1 and a second arc CA2.

For example, as illustrated in FIGS. 12 and 19, the first arc CA1 may be an ideal arc on which bottom width lines WL of a total of six anterior teeth including at least the first anterior teeth T1, e.g., the first anterior teeth T1, the second anterior teeth T2, and the third anterior teeth T3, are located.

In addition, for example, the second arc CA2 may be an ideal arc on which bottom width lines WL of teeth including at least posterior teeth T7, e.g., the fourth teeth T4, the fifth teeth T5, the sixth teeth T6, the seventh teeth T7, and the eighth teeth T8, are located and which is located at an inner side of the first arc CA1 to be spaced apart from the first arc CA1.

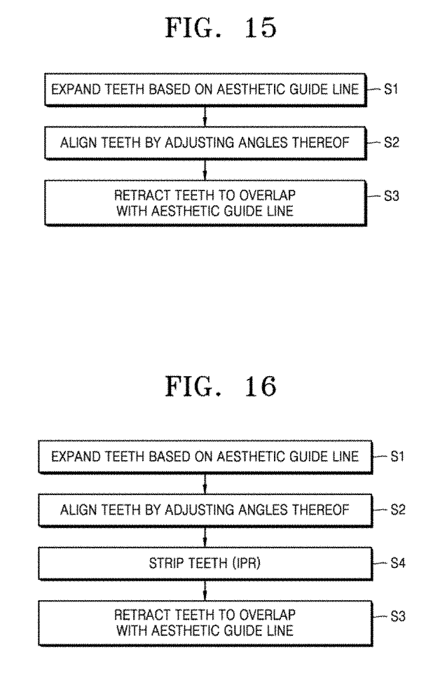

FIG. 15 is a flowchart of an orthodontic treatment method using an aesthetic guide line KL, according to some embodiments of the present invention.

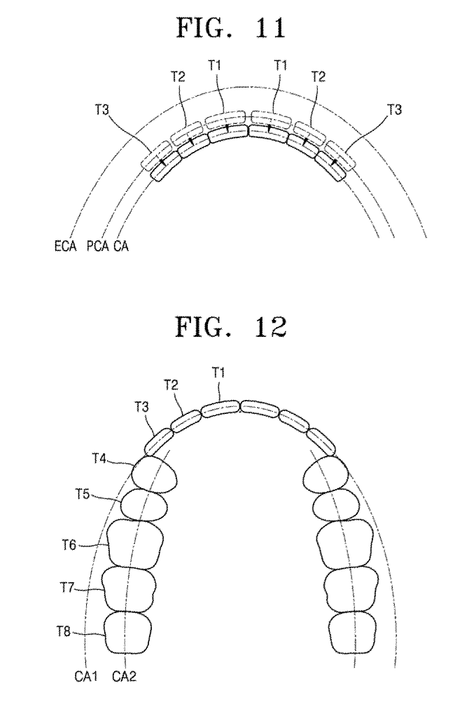

Accordingly, as illustrated in FIGS. 1 to 15, the orthodontic treatment method according to some embodiments of the present invention may include an expansion stage S1 for expanding anterior teeth T1 or other teeth T in such a manner that front lines FL of the anterior teeth T1 move to a front side of the aesthetic guide line KL corresponding to a virtual line obtained by connecting a first skin point n′ located in front of a nasion n from which nasal bones start based on a profile skull line L of an orthodontic patient, to a second skin point p′ located in front of a pogonion p, an alignment stage S2 for aligning the anterior teeth T1 or the other teeth T from a first angle K1 to a second angle K2 in such a manner that central tangent lines FL′ of the front lines FL of the anterior teeth T1 are parallel to the aesthetic guide line KL, and a retraction stage S3 for retracting the anterior teeth T1 or the other teeth T in such a manner that the central tangent lines FL′ of the front lines FL of the anterior teeth T1 overlap with the aesthetic guide line KL or are located at an inner side of the aesthetic guide line KL.

Therefore, as described above, since a clear aligner is manufactured by establishing an aesthetic guide line corresponding to an ideal orthodontic model and then simulating expansion, alignment, and retraction of teeth on a computer using a virtual orthodontic arc based on the aesthetic guide line, the teeth may be ideally straightened to achieve the most aesthetically beautiful face of an orthodontic patient, satisfaction of the orthodontic patient and acquaintances thereof may be remarkably improved, a retreatment rate may be reduced, and equal results of simulation may be derived irrespective of experience or ability of operators and thus product uniformity or quality of the clear aligner may be greatly improved.

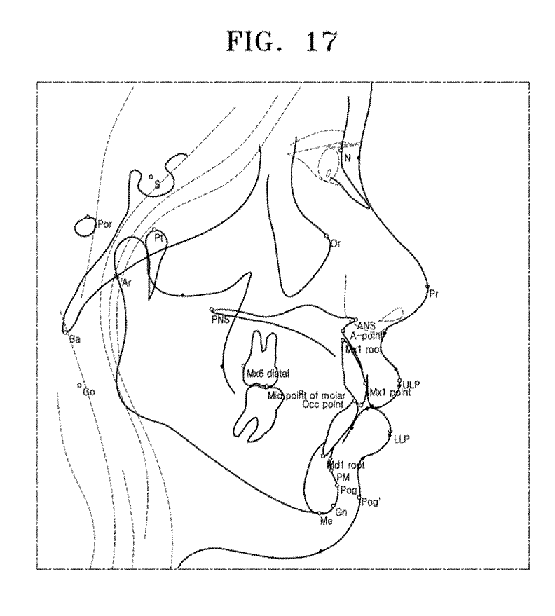

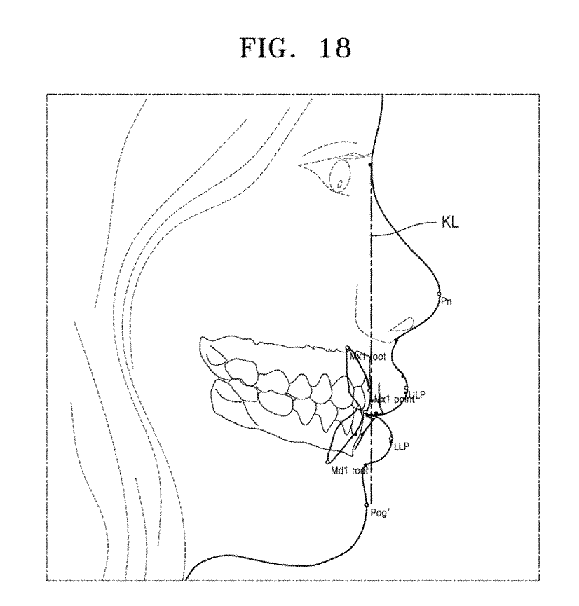

FIG. 17 is a side view of a face before orthodontic treatment showing an aesthetic guide line used in an orthodontic treatment method, according to still other embodiments of the present invention, and FIG. 18 is a side view of the face after orthodontic treatment showing the aesthetic guide line used in the orthodontic treatment method, according to still other embodiments of the present invention.

As illustrated in FIGS. 17 and 18, according to the present invention, even buck teeth may be straightened not only to be balanced with the other teeth but also to look good within a whole face through expansion, alignment, and retraction using the most aesthetically beautiful model based on the aesthetic guide line KL.

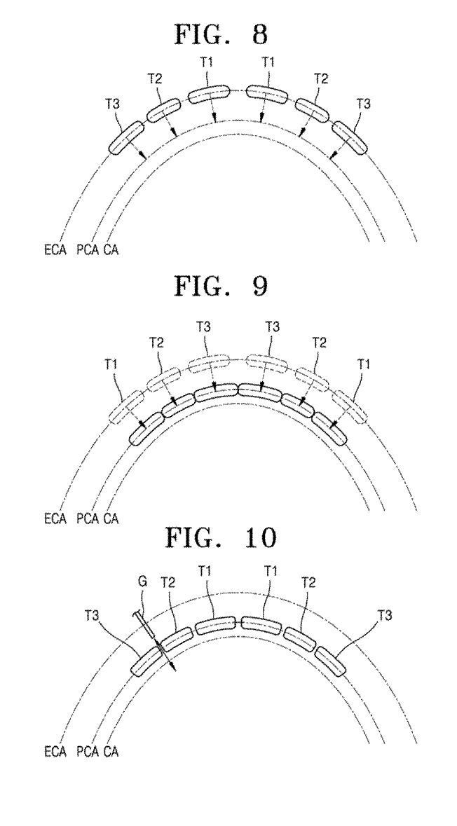

FIGS. 8 to 11 are bottom views of an upper jaw sequentially showing operations for interproximal reduction (IPR)/stripping in an orthodontic treatment method using an aesthetic guide line, according to other embodiments of the present invention.

As illustrated in FIGS. 8 to 11, the orthodontic treatment method according to other embodiments of the present invention may further include an IRP/stripping stage S4 for placing the teeth T on a preliminary orthodontic arc PCA provided in front of the virtual orthodontic arc CA to closely contact each other with no distance therebetween and stripping side surfaces of one or more of the teeth T using a grinder G, after the above-described alignment stage S2.

That is, the teeth T including the anterior teeth T1 located on the virtual expanded orthodontic arc ECA as illustrated in FIG. 8 may be placed on the preliminary orthodontic arc PCA to closely contact each other with no distance therebetween as illustrated in FIG. 9, side surfaces of one or more of the teeth T may be stripped using the grinder G as illustrated in FIG. 10, and then the anterior teeth T1 or the other teeth T may be retracted to the orthodontic arc CA.

FIG. 16 is a flowchart of an orthodontic treatment method using an aesthetic guide line, according to other embodiments of the present invention.

Accordingly, as illustrated in FIGS. 8 to 16, the orthodontic treatment method according to other embodiments of the present invention may include an expansion stage S1 for expanding anterior teeth T1 or other teeth T in such a manner that front lines FL of the anterior teeth T1 move to a front side of the aesthetic guide line KL corresponding to a virtual line obtained by connecting a first skin point n′ located in front of a nasion n from which nasal bones start based on a profile skull line L (See FIG. 1) of an orthodontic patient, to a second skin point p′ located in front of a pogonion p, an alignment stage S2 for aligning the anterior teeth T1 or the other teeth T from a first angle K1 to a second angle K2 in such a manner that central tangent lines FL′ of the front lines FL of the anterior teeth T1 are parallel to the aesthetic guide line KL, an IRP/stripping stage S4 for placing the teeth T on the preliminary orthodontic arc PCA provided in front of the virtual orthodontic arc CA to closely contact each other with no distance therebetween and stripping side surfaces of one or more of the teeth T, and a retraction stage S3 for retracting the anterior teeth T1 or the other teeth T in such a manner that the central tangent lines FL′ of the front lines FL of the anterior teeth T1 overlap with the aesthetic guide line KL or are located at an inner side of the aesthetic guide line KL.

Therefore, when IRP/stripping is needed, teeth may be straightened based on an ideal teeth model using the above-described preliminary orthodontic arc PCA.

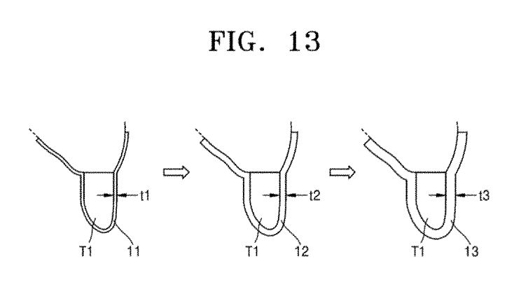

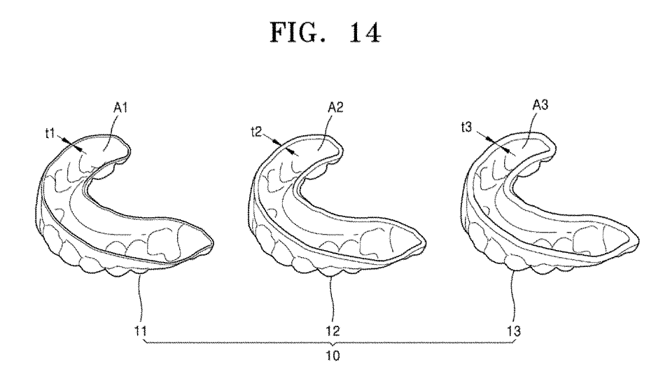

FIG. 13 is a cross-sectional view of a clear aligner set 10 manufactured using an orthodontic treatment method using an aesthetic guide line, according to some embodiments of the present invention, and FIG. 14 is a perspective view of the clear aligner set 10 of FIG. 13.

As illustrated in FIGS. 13 and 14, the orthodontic treatment method according to some embodiments of the present invention may use the clear aligner set 10 for expanding, aligning, and retracting the anterior teeth T1.

For example, as illustrated in FIGS. 13 and 14, the clear aligner set 10 may include three clear aligners 11, 12, and 13 having the same orthodontic space A but formed of different-strength materials, e.g., soft, medium, and hard materials, or having different thicknesses, e.g., first, second, and third thicknesses t1, t2, and t3, to apply gradually increasing orthodontic forces to the teeth T in consideration of a recovery period of a human body.

Accordingly, since gradually increasing orthodontic forces may be applied for a certain period of time using a set of the three clear aligners 11, 12, and 13 having the same orthodontic space A, the teeth T may be safely and comfortably straightened without excessively damaging an orthodontic patient.

As described above, according to some embodiments of the present invention, since a clear aligner is manufactured through simulation using an aesthetic guide line and first and second virtual orthodontic arcs based on the aesthetic guide line, teeth may be ideally straightened to achieve the most aesthetically beautiful face of an orthodontic patient, satisfaction of the orthodontic patient and acquaintances thereof may be remarkably improved, a retreatment rate may be reduced, and equal results of simulation may be derived irrespective of experience or ability of operators and thus product uniformity or quality of the clear aligner may be greatly improved. However, the scope of the present invention is not limited to the above effects.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. An orthodontic treatment method using an aesthetic guide line, the method comprising:
an expansion stage for expanding anterior teeth or other teeth in such a manner that front lines of the anterior teeth move to a front side of the aesthetic guide line corresponding to a virtual line obtained by connecting a first skin point located in front of a nasion from which nasal bones start based on a profile skull line of an orthodontic patient, to a second skin point located in front of a pogonion;
an alignment stage for aligning the anterior teeth or the other teeth from a first angle to a second angle in such a manner that central tangent lines of the front lines of the anterior teeth are parallel to the aesthetic guide line; and
a retraction stage for retracting the anterior teeth or the other teeth in such a manner that the central tangent lines of the front lines of the anterior teeth overlap with the aesthetic guide line or are located at an inner side of the aesthetic guide line.

2. The orthodontic treatment method of claim 1, wherein, in the expansion stage, the teeth comprising the anterior teeth are expanded and spaced apart from each other by a distance in such a manner that bottom width lines of the teeth are located on a virtual expanded orthodontic arc.

3. The orthodontic treatment method of claim 2, wherein the distance is 0.01 mm to 0.5 mm in such a manner that the teeth are rotatable.

4. The orthodontic treatment method of claim 1, wherein, in the retraction stage, the teeth comprising the anterior teeth are retracted to closely contact each other with no distance therebetween in such a manner that bottom width lines of the teeth are located on a virtual orthodontic arc or located at an inner side of the orthodontic arc.

5. The orthodontic treatment method of claim 4, wherein the orthodontic arc comprises:
a first arc on which bottom width lines of the teeth comprising at least the anterior teeth are located; and
a second arc on which bottom width lines of the teeth comprising at least posterior teeth are located and which is located at an inner side of the first arc to be spaced apart from the first arc.

6. The orthodontic treatment method of claim 1, further comprising an interproximal reduction (IPR)/stripping stage for placing the teeth on a preliminary orthodontic arc provided in front of a virtual orthodontic arc to closely contact each other with no distance therebetween and stripping side surfaces of one or more of the teeth, after the alignment stage,
wherein, in the retraction stage, the anterior teeth or the other teeth located on the preliminary orthodontic arc are retracted to the orthodontic arc in such a manner that the front lines of the anterior teeth overlap with the aesthetic guide line or are located at an inner side of the aesthetic guide line.

7. The orthodontic treatment method of claim 1, wherein a clear aligner set for expanding, aligning, and retracting the anterior teeth is used.

8. The orthodontic treatment method of claim 7, wherein the clear aligner set comprises three clear aligners having the same orthodontic space but formed of soft, medium, and hard materials or having first, second, and third thicknesses to apply gradually increasing orthodontic forces to the teeth in consideration of a recovery period of a human body.
